(19) United States
(12) Patent Application Publication
(10) Pub. No.: US 2025/0144558 A1
(43) Pub. Date: May 8, 2025

(54) EXTREME TEMPERATURE DIRECT AIR CAPTURE SOLVENT

(71) Applicant: UT-Battelle, LLC, Oak Ridge, TN (US)

(72) Inventors: Gyoung Gug Jang, Knoxville, TN (US); Radu Custelcean, Beavercreek, OH (US); Abishek Kasturi, Oak Ridge, TN (US); David S. Sholl, Oak Ridge, TN (US); Diana Stamberga, Lenoir City, TN (US); Josh Thompson, Knoxville, TN (US); Constantinos Tsouris, Oak Ridge, TN (US)

(21) Appl. No.: 18/934,709

(22) Filed: Nov. 1, 2024

Related U.S. Application Data
(60) Provisional application No. 63/547,173, filed on Nov. 3, 2023.

(51) Int. Cl. B01D 53/14

(52) U.S. Cl. CPC B01D 53/1493; B01D 53/1475; B01D 2252/20494; B01D 2257/504

(57) ABSTRACT

A solvent formulation for the direct air capture of carbon dioxide is provided. The solvent formulation includes an amino acid salt, a polar solvent and an antifreeze agent. A direct air capture system for the direct air capture of carbon dioxide is further provided. The direct air capture system incudes a desorption column, a gas separator, and an air contactor. The desorption column, gas-liquid separator, and air contactor are in fluid communication. The air contactor includes the solvent formulation.

### CROSS-REFERENCE TO RELATED APPLICATIONS

This application claims the benefit of U.S. Provisional Application 63/547,173, filed Nov. 3, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF THE INVENTION

The present invention relates to a direct air capture (DAC) solvent, especially for extreme temperatures, particularly cold temperatures.

### BACKGROUND OF THE INVENTION

DAC solvents are compositions capable of reducing the CO₂ concentration in the atmosphere. DAC solvents rely on the assumption that CO₂ capture is not necessarily tied to point sources, such as existing power or industrial plants, but can be conducted anywhere. DAC facilities may be deployed anywhere in the world, allowing the DAC facilities to mitigate carbon emissions from fixed and/or distributed sources, including legacy emissions. Existing DAC systems require robust designs to allow these systems to operate under a variety of seasonal and local weather conditions to effectively capture CO₂ from the atmosphere.

One area of particular interest for the development of DAC facilities is the Great Plains of the American West. The Great Plains are of particular interest because of the region's high capacity for geological storage, existing support infrastructure, geothermal suitability, and natural gas availability. Unfortunately, one of the challenges with potential DAC facilities located in the Great Plains are low temperatures that may impair the efficacy of DAC facilities for carbon capture. Therefore, there remains a need to develop a low freezing point DAC solvent.

### SUMMARY OF THE INVENTION

A solvent formulation for the direct air capture of carbon dioxide is provided. The solvent formulation includes an amino acid salt, a polar solvent, and an antifreeze agent.

A direct air capture (DAC) system for the direct air capture of carbon dioxide is also provided. The DAC system includes a desorption column, a gas-liquid separator, and an air contactor. The desorption column, gas-liquid separator, and air contactor are in fluid communication. The air contactor includes a solvent formulation including an amino acid salt, a polar solvent, and an antifreeze agent.

These and other features of the invention will be more fully understood and appreciated by reference to the description of the embodiments.

### BRIEF DESCRIPTION OF THE FIGURES

FIG. 1 is a representational depiction of the DAC solvent formulation including an ethylene glycol anti-freeze agent and potassium sarcosinate.

FIG. 2 is a schematic depiction of a DAC system according to one embodiment.

FIG. 3A is a graphical depiction of heat flow plotted as a function of temperature for several exemplary embodiments for cooling of the DAC solvent formulation from 40 to −50° C.

FIG. 3B is a graphical depiction of heat flow plotted as a function of temperature for several exemplary embodiments for heating of the DAC solvent formulation from −50 to 40° C.

FIG. 3C is a graphical depiction of heat flow plotted as a function of temperature for another several exemplary embodiments for cooling of the DAC solvent formulation from 40 to −50° C.

FIG. 3D is a graphical depiction of heat flow plotted as a function of temperature for another several exemplary embodiments for heating of the DAC solvent formulation from −50 to 40° C.

FIG. 4A is a graphical depiction of dynamic viscosity plotted as a function of temperature for several exemplary embodiments.

FIG. 4B is a graphical depiction of density plotted as a function of temperature for several exemplary embodiments.

FIG. 4C is a graphical depiction of dynamic viscosity plotted as a function of temperature for another several embodiments.

FIG. 4D is a graphical depiction of dynamic viscosity plotted as a function of temperature for another several embodiments.

FIG. 5 is a schematic depiction of an experimental apparatus used to measure the CO₂ flux of various embodiments of the DAC solvent formulation.

FIG. 6 is a plot of CO₂ loading and pH plotted as a function of elapsed time.

### DETAILED DESCRIPTION OF THE CURRENT EMBODIMENTS

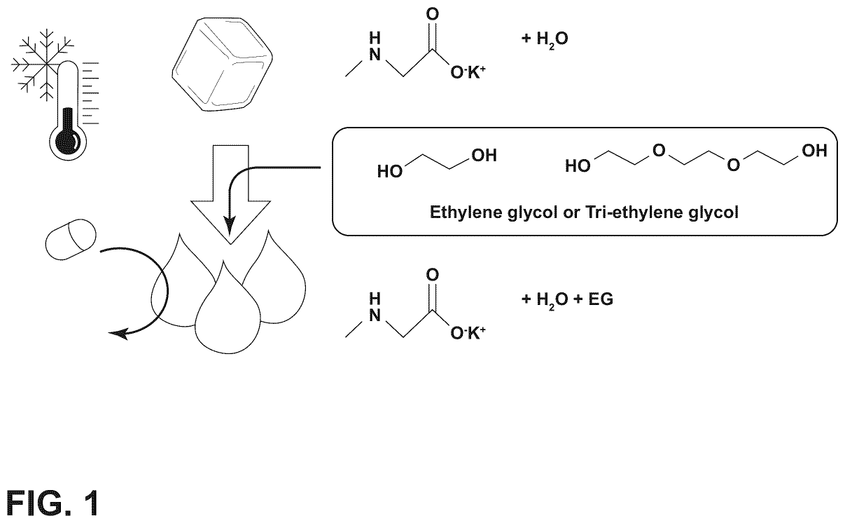

As discussed herein, the current embodiments relate to a solvent formulation for the direct air capture (DAC) of carbon dioxide. The solvent formulation includes an amino acid salt, a polar solvent, and an antifreeze agent. A representational depiction of the solvent formulation is shown in FIG. 1. The solvent formulation is workable in a wide range of environmental conditions. The solvent formulation has relatively high CO₂ capacity, relatively low regeneration temperature, low potential for contaminating the environment, low vapor pressure, low evaporation rate, and good chemical stability. The solvent formulation is particularly well suited to be used in cold weather during winter seasons because of its low freezing temperature. The freezing point may be −20° C. or lower, alternatively −30° C. or lower, alternatively −40° C. or lower, or alternatively −50° C. or lower.

The solvent formulation includes an amino acid salt. Amino acid salts are salts that comprise an amino acid-based anion and a cation. Amino acid salts are formed when an amino acid reacts with a base (e.g., KOH), resulting in a salt that can effectively absorb CO₂. The amino acid provides functional groups that can interact with CO₂, facilitating its capture in the solvent formulation. The amino acid salts are reactable with CO₂ to form carbamates, bicarbonates, or similar compounds. Amino acid salts are particularly effective because they have relatively low regeneration energy requirements compared to other CO₂ absorbents. The amino acid salt includes a cation. Generally, the cation is selected from the group consisting of lithium, sodium, potassium, rubidium, cesium, or a combination thereof. The amino acid salt includes an anion. The anion may be an amino acid derivative, including glycinate, sarcosinate, lysinate, glutamate, aspartate, histidinate, arginate, cyseinate, prolinate, and other similar compounds. In specific embodiments, the anion is selected from the group consisting of sarcosinate, glycinate, or a combination thereof. The amino acid salt is present in the solvent formulation in a concentration of from 1 to 6 M, alternatively 2 to 4 M, or alternatively about 3 M.

The solvent formulation includes a polar solvent. Generally, the polar solvent comprises, alternatively consists essentially of, alternatively consists of water. In alternative embodiments, the solvent formulation comprises an alcohol, dimethyl sulfoxide, glycerol, or other similar compounds.

The solvent formulation includes an antifreeze agent. Non-limiting examples of the antifreeze agent include ethylene glycol, propylene glycol, methanol, glycerol, sorbitol, mannitol, calcium chloride, sodium chloride, potassium chloride, formic acid, acetic acid, urea, diethylene glycol, triethylene glycol, pentaerythritol, ammonium nitrate, lithium bromide, nonionic surfactants, and polyethylene glycol. The solvent formulation includes an antifreeze agent in an amount of 1 to 40 vol. %, alternatively 1 to 35 vol. %, alternatively 1 to 30 vol. %, alternatively 1 to 20 vol. %, alternatively 25 to 35 vol. %, alternatively 27.5 to 32.5 vol. %, alternatively about 30 vol. %, alternatively 5 to 15 vol. %, alternatively 7.5 to 12.5 vol. %, alternatively about 10 vol. %, or alternatively 1 to 2 vol. %. In certain embodiments, the antifreeze agent comprises ethylene glycol or triethylene glycol. In specific embodiments, the solvent formulation comprises ethylene glycol in an amount of 1 to 20 vol. %. In particular embodiments, the solvent formulations comprise triethylene glycol in an amount of 1 to 35 vol. %.

In some embodiments, the solvent formulation includes a polyol. In embodiments where the solvent formulation includes a polyol, the polyol is selected such that the antifreeze agent is a different compound than the polyol. The addition of polyols in the solvent formulation can increase the CO₂ absorption of the solvent formulation, can adjust the viscosity of the solvent formulation to improve the flow characteristics and enhance mass transfer during the absorption process, reduce volatility, and/or aid in the regeneration of the solvent formulation. Generally, the polyol comprises, alternatively consists essentially of, alternatively consists of a polyethylene glycol.

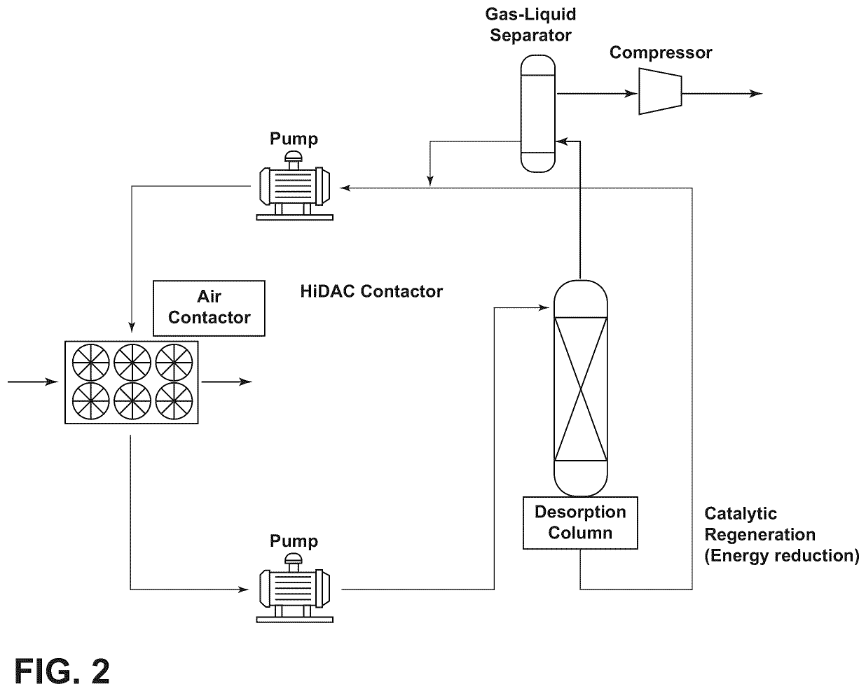

A direct air capture (DAC) system for the direct air capture of carbon dioxide is also provided. The DAC system is generally depicted in FIG. 2. The DAC system includes a desorption column, a gas-liquid separator, and an air contactor. The desorption column, gas-liquid separator, and air contactor are in fluid communication. The air contactor comprises a solvent formulation including an amino acid salt, a polar solvent, and an antifreeze agent.

The desorption column is intended to separate captured CO₂ from the solvent formulation, allowing the solvent formulation to be reused for further CO₂ capture. Desorption typically involves increasing the temperature of the solvent formulation or reducing pressure to force release of the CO₂. The desorption column generally includes a column body with a vertical cylindrical structure. The desorption column includes a heating element to increase the temperature of the solvent formulation. The desorption column further defines an inlet port and an outlet port for entry of the CO₂ loaded solvent formulation into the desorption column and exit of the pristine or de-loaded solvent formulation.

The gas-liquid separator is used to separate a gas phase comprising CO₂ from the liquid phase solvent formulation after the CO₂ is desorbed from the solvent formulation. The gas-liquid separator generally includes a separator vessel defining an inlet port, a gas outlet, and a liquid outlet. The separator vessel generally includes a cylindrical tank designed to allow for gravity-driven separation of gas and liquid. The sequestered CO₂ gas exits the gas-liquid separator via the gas outlet and the solvent formulation exits the liquid outlet.

The air contactor is used to facilitate the contact of ambient air and the solvent formulation. The air contactor is designed to maximize contact between the ambient air and the solvent formulation, thereby enhancing the efficacy of CO₂ absorption. The air contactor includes a contacting unit where the ambient air and solvent formulation contact. The air contactor defines an air inlet through which the ambient air enters the contacting unit. The air contactor also defines a drainage outlet through which the solvent formulation exits. The contacting unit can be a packed bed, spray tower, or thin-film contacting unit.

The DAC system may include one or more pumps. In some embodiments, one pump is disposed between the drainage outlet of the air contactor and the inlet port of the desorption column and another pump is disposed between the outlet port of the desorption column and the air contactor. In particular embodiments, the DAC system includes a compressor disposed following the gas outlet of the gas-liquid separator.

### EXAMPLES

The present composition is further described in connection with the following examples, which are non-limiting.

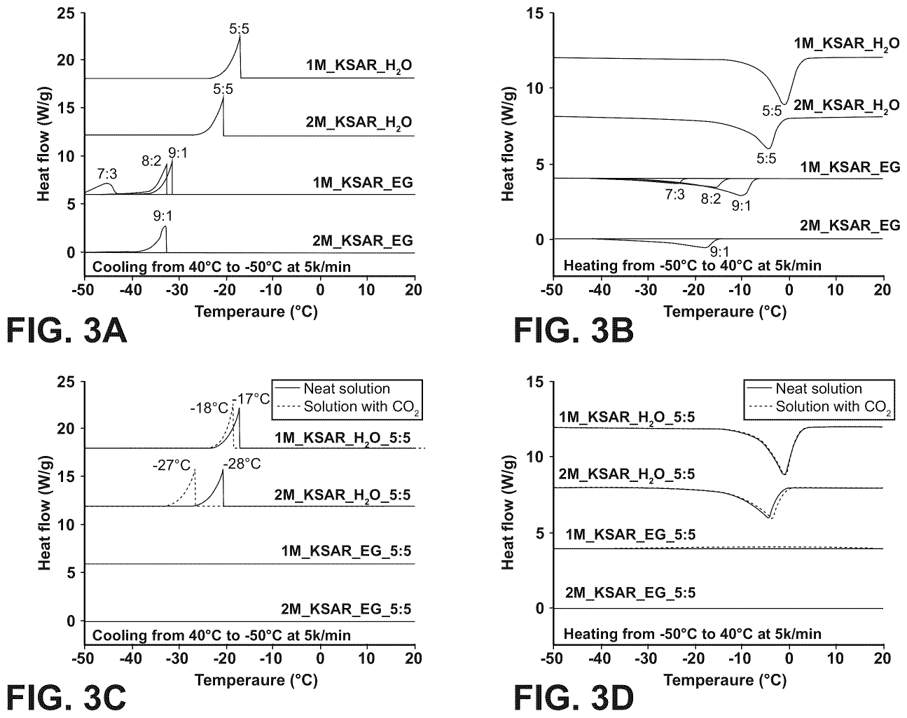

Differential Scanning Calorimetry (DSC) results, shown in FIG. 3A, indicate a sharp exothermic phase-change of 0.5 M potassium sarcosinate (K-SAR) (i.e., a mixture of 1 M K-SAR with H₂O at 1:1 volumetric mix ratio) occurring at −17° C., which is the freezing point. By increasing the K-SAR concentration to 1 M (i.e., a mixture of 2 M K-SAR with H₂O at 1:1 volumetric ratio), the freezing point is further reduced to −20° C. The addition of ethylene glycol (EG) decreases the freezing points of the mixtures. The decrease is even more pronounced as the mixing ratio increases. Once the mixing ratio is beyond 6:4, the freezing point is further reduced to below −50° C. At higher concentrations of K-SAR, such as 2 M, further reduction of the freezing point is observed. Pristine and CO₂ loaded 2 M K-SAR with water mixture can have freezing points reduced to −26° C. and −32° C., respectively. The freezing point of a K-SAR solvent can be further reduced by increasing concentration of K-SAR and adding additives such as polyethylene glycol or TEG. A 2 M K-SAR mixture adjusted to a 1:1 ratio may further have its freezing point reduced below −50° C. through the introduction of EG or tri-ethylene glycol (TEG).

FIG. 3B shows the melting point of the solvent formulation according to some embodiments. The melting point of 0.5 M K-SAR is observed at −2° C., which is higher than the freezing point at −10° C. Similar behaviors of increased melting points with respect to freezing points were observed in other solvent formulation embodiments. The effect of the CO₂ loading on the freezing point, depicted in FIG. 3C, indicates that freezing point reduction also occurs with increased CO₂ loading. The freezing point of 1 M K-SAR (corresponding to a ratio of 2 M K-SAR added to H₂O at 1:1) with CO₂ loading (0.945 mol/mol) has a freezing point of −27° C., which is lower than that of pristine 1 M K-SAR with 0.088 mol/mol of CO₂ loading.

Regarding embodiments where the solvent formulation comprises EG or TEG, the freezing point was not observed due to the high mixing ratio of the additive and detection limit of the freezing point. FIG. 3D shows that the melting points of both pristine and CO₂ loaded solvent formulas exhibit similar patterns.

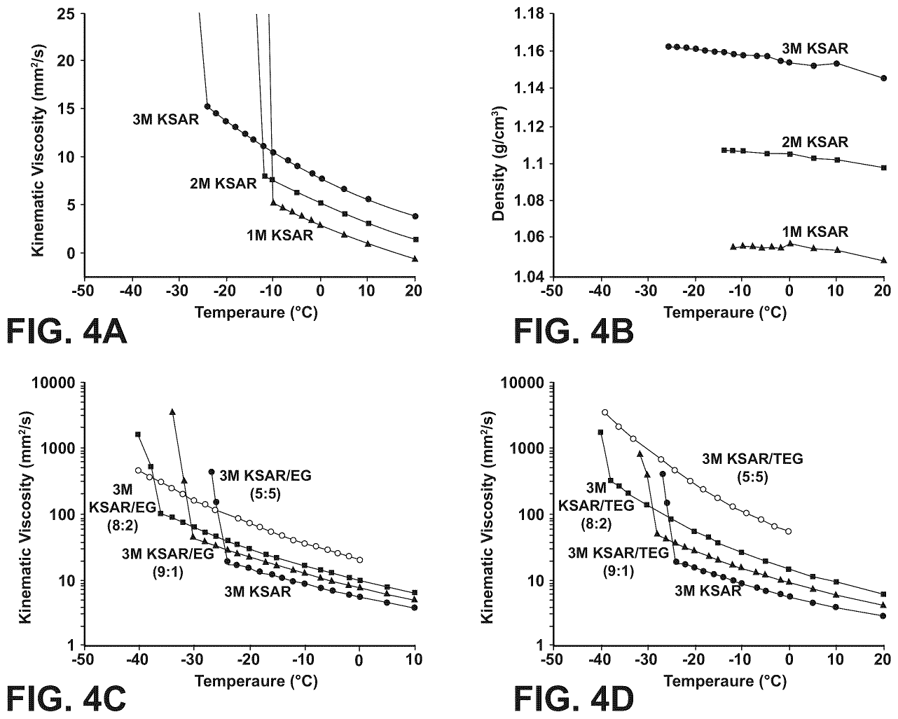

Kinematic viscosity measurements were conducted to identify the freezing point and viscosity of solvent formulations according to various embodiments. Viscosity is an important parameter affecting CO₂ absorption rate and therefore operating costs. As shown in FIG. 4A, the viscosity gradually increases decreasing temperature. After −10° C., the viscosity of the 1 M K-SAR surges, indicating freezing.

It is evident that the viscosity increases and the freezing point further decreases with increasing K-SAR solvent concentrations. Regarding the 3 M K-SAR solvent formulation, freezing points were detected at −28° C. Notably, the freezing point was measured by the viscometer is much higher than the freezing point measured by DSC. This discrepancy may be associated with different measurements each technique provides. DSC measures the heat flow associated with phase transition, while viscosity measurement assesses a substance's resistance to flow. Viscosity is a measurement that may indicate phase transition. The density of K-SAR solvent, as shown in FIG. 4B, increases with concentration, while the effect of temperature is minimal. FIG. 4C indicates that the addition of EG significantly decreases the freezing point. A 10% addition further decreases the freezing point from −26° C. to −32° C. At 50% ratio, the freezing point was not observed in the DSC detection range. Addition of TEG, as shown in FIG. 4D, exhibits a similar freezing point reduction effect. However, the increase in viscosity is much higher than with the addition of EG. EG (C₂H₄O₂) is a small molecule with a molecular weight of 62.07 g/mol, while TEG (C₆H₁₄O₄) is a larger molecule with a molecular weight of 150.174 g/mol. EG is a common hydrogen bonding donor, which can bind CO₂ and yield carboxylate, carbamate, and carbonate species. EG increases CO₂ loading and facilitates CO₂ absorption rate. The addition of EG further improves K-SAR performance for CO₂ absorption, as well as freezing point reduction. All exemplary embodiments of the solvent formulation show no precipitation, and other physical changes were not observed after mixing of the components and CO₂ loading.

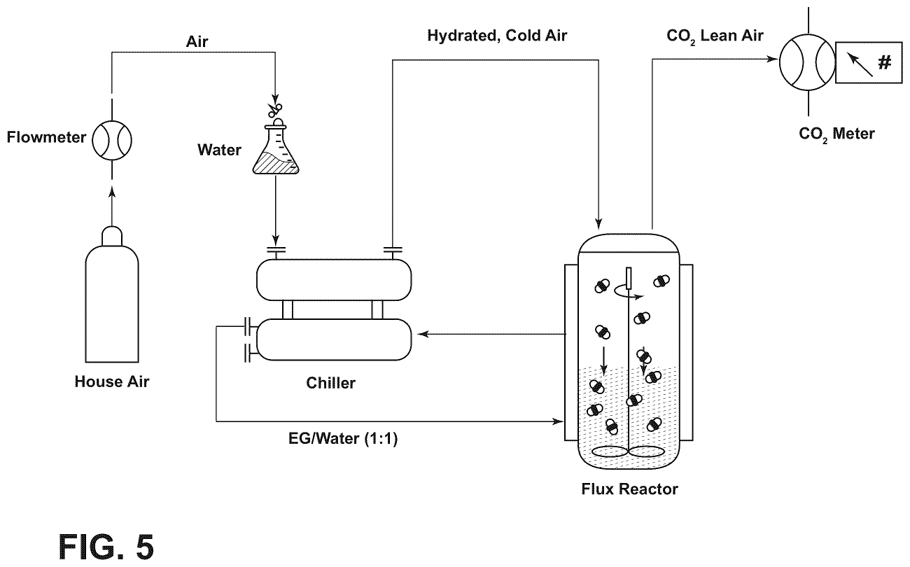

The atmospheric CO₂-absorption rate of the solvent formulation as a function of temperatures as determined by a custom-built apparatus schematically depicted in FIG. 5. This setup involves a chiller to cool down the air and solvent in the reactor. The incoming air passed through a water bubbler to become hydrated and the proceed through the chiller, which cooled down the air to prevent moisture loss from the solvent formulation. The coolant passed through the double wall reactor to further lower the solvent temperature. The solvent was stirred at 50 RPM to maintain a laminar flow and ensure proper mixing. A CO₂ meter was used to detect the CO₂ concentration in the outgoing air. Samples of the solvent were collected over time, and the CO₂ concentration in these samples was measured by total inorganic carbon analysis (TiC).

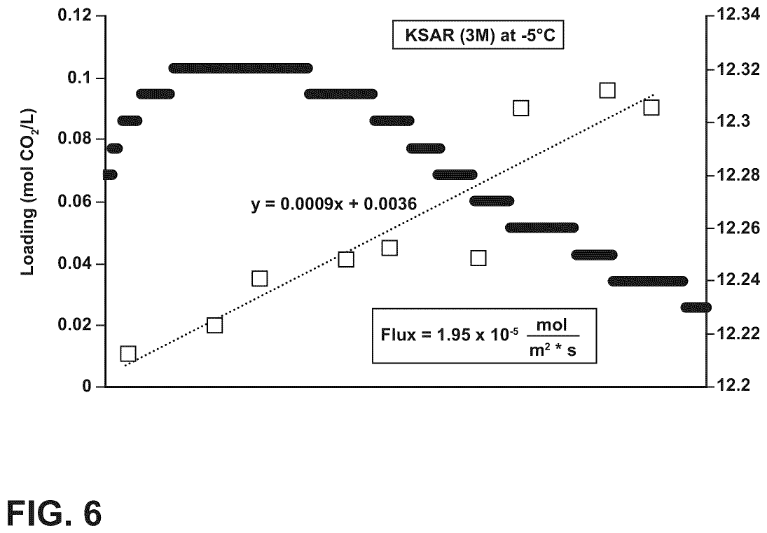

The calculation of atmospheric CO₂ flux was determined based on CO₂ loading of the solvent over time. FIG. 6 illustrates CO₂ loading and the corresponding pH measurement over time. In FIG. 6, the CO₂ loading of 3 M K-SAR at −5° C. increases over 100 hours of air exposure. Correspondingly, the pH values increase up to 20 hours and then decrease over time as the sarcosinate forms carbonate and carbamate, resulting in a pH drop. The least square line through the CO₂ loading data allowed for the determination of a slope. Using the equation presented below, the CO₂ flux of the 3 M K-SAR solvent formulation at −5° C. was determined to be 1.95×10⁻⁵ mol/m²s.

$$Flux ( \frac{mol {CO}_{2}}{{m}^{2} s} ) = \frac{Slope ( 0.0009 \frac{mol}{L hr} )}{Surface Area ( 0.0064 {m}^{2} )} \times \frac{hr}{3600 s}$$

Several anti-freezing DAC solvent compositions were prepared. Specifically, Examples 1 and 5 were prepared as shown in Table 1 below.

TABLE 1

| Example 1 | Example 2 | Example 3 | Example 4 | Example 5 |
|---|---|---|---|---|
| 1M | 3M | 1M | 1M | 1M |
| K-SAR | K-SAR | K-SAR in | K-SAR in | K-SAR in |
| | | 1.5% aqueous | 10% aqueous | 30% aqueous |
| | | TEG | EG | TEG |

Various properties (e.g., CO₂ flux, freezing point, viscosity) are shown in Tables 2 and 3 below. The CO₂ flux of the K-SAR solvent is determined as a function of temperature. The experimental value of CO₂ flux of 1 M K-SAR at 25° C. is 5.9×10⁻⁵ mol/m²s, which closely matches the theoretical value calculated at 5.4×10⁻⁵ mol/m²s. Notably, the 3 M K-SAR solvent formulation enables operation at −20° C. without freezing, resulting in a CO₂ flux of 8.7×10⁻⁶ mol/m²s while 1 M K-SAR solvent formulations cannot operate under the same conditions.

The heat of desorption for 3 M K-SAR is 3.68 GJ/tCO₂, which is similar to conventional industrial solid sorbents. For example, Carbon Engineering (CaCO₃) and Climeworks (cellulose-amine polymer) consume approximately 8.8 and 7.2 GJ/tCO₂ in their respective processes. Notably, Examples 4 and 5 demonstrate excellent freezing point reduction while maintaining relatively low increases in viscosity, CO₂ flux at low temperatures, and excellent regeneration energies.

TABLE 2

| | Example 1 | Example 2 | Example 3 | Example 4 | Example 5 |
|---|---|---|---|---|---|
| Temperature | (CO₂ flux | (CO₂ flux | (CO₂ flux | (CO₂ flux | (CO₂ flux |
| (° C.) | mol/m²s) | mol/m²s) | mol/m²s) | mol/m²s) | mol/m²s) |
| 45 | 8.0 × 10⁻⁵ | 12.2 × 10⁻⁵ | — | — | — |
| 35 | 6.5 × 10⁻⁵ | 10.8 × 10⁻⁵ | — | — | — |
| 25 | 5.9 × 10⁻⁵ | 10.5 × 10⁻⁵ | — | 5.1 × 10⁻⁵ | — |
| 15 | 4.2 × 10⁻⁵ | 5.5 × 10⁻⁵ | 4.0 × 10⁻⁵ | 3.0 × 10⁻⁵ | — |
| 5 | 3.9 × 10⁻⁵ | 2.6 × 10⁻⁵ | 2.9 × 10⁻⁵ | 2.8 × 10⁻⁵ | — |
| −5 | 1.3 × 10⁻⁵ | 1.9 × 10⁻⁵ | 1.4 × 10⁻⁵ | 1.2 × 10⁻⁵ | — |
| −20 | — | 8.7 × 10⁻⁶ | — | 5.4 × 10⁻⁶ | — |

TABLE 3

| | Example 1 | Example 2 | Example 3 | Example 4 | Example 5 |
|---|---|---|---|---|---|
| Freezing Point | −21° C./ | /−26° C. | −21° C./ | −32° C./ | /−23° C. |
| (DSC/Viscosity) | −10° C. | | −13° C. | −18° C. | |
| Kinematic | 2.0/ | 4.6/ | 2.2/ | 2.8/ | 7.2/ |
| Viscosity | 2.9 | 6.9 | 3.2 | 4.1 | 11.5 |
| (mm²/s) at | | | | | |
| 5° C./−5° C. | | | | | |
| Regeneration | — | 3.68 | — | — | — |
| Energy | | | | | |
| (GJ/tCO₂) | | | | | |

Table 4 below records the contact angles of various embodiments of solvent formulation. Lower contact angles result in better surface spreading. Chemical reactions with the solvent formulation can only occur where the liquid spreads (i.e., when there is lower contact angle). As shown in Table 4, stainless steel 410 has the best surface spreading for the exemplary embodiments. Increasing concentrations of the amino acid salts results in lower contact angles. Increased CO₂ loading also results in lower contact angles.

TABLE 4

| Solvent | Stainless Steel 410 | Glass | PVC | Acrylic |
|---|---|---|---|---|
| Water | 90.2 ± 6.1 | 48.1 ± 8.1 | 75.8 ± 1.8 | 102.6 ± 6.8 |
| K-SAR 1M | 32.3 ± 10.9 | 46.3 ± 5.6 | 77.9 ± 3.6 | 69.1 ± 5.9 |
| K-SAR 2M | 29.8 ± 11.7 | 44.9 ± 2.4 | 77.8 ± 6.2 | 68.9 ± 5.8 |
| K-SAR 3M | 20.8 ± 7.3 | 36.3 ± 6.5 | 74.7 ± 16.8 | 70.4 ± 3.2 |
| CO₂ Loaded K-SAR 1M | 16.2 ± 5.5 | 33.1 ± 15.1 | 67.3 ± 12.3 | 90.1 ± 7.8 |
| CO₂ Loaded K-SAR 2M | 14.0 ± 7.3 | 34.6 ± 9.1 | 78.9 ± 3.8 | 94.3 ± 4.7 |
| CO₂ Loaded K-SAR 3M | 13.7 ±7.4 | 47.2 ± 2.6 | 89.9 ± 8.3 | 104.4 ± 8.7 |
| K-SAR 3M + EG (10 vol. %) | 22.3 ± 14.8 | 37.1 ± 4.9 | 83.4 ± 5.9 | — |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. As used herein, the term “about” indicates values within the range of ±25%, alternatively ±10%, alternatively ±5%, alternatively ±1% of the modified value.

1. A solvent formulation for the direct air capture of carbon dioxide, the solvent formulation comprising:
an amino acid salt;
a polar solvent; and
an antifreeze agent.

2. The solvent formulation of claim 1, wherein the polar solvent comprises water.

3. The solvent formulation of claim 1, wherein the amino acid salt comprises a cation selected from the group consisting of lithium, sodium, potassium, rubidium, cesium, or a combination thereof.

4. The solvent formulation of claim 1, wherein the amino acid salt comprises an anion selected from the group consisting of glycinate, sarcosinate, lysinate, glutamate, aspartate, histidinate, arginate, cyseinate, prolinate or a combination thereof.

5. The solvent formulation of claim 1, wherein the antifreeze agent comprises a glycol.

6. The solvent formulation of claim 5, wherein the antifreeze agent comprises ethylene glycol or triethylene glycol.

7. The solvent formulation of claim 6, wherein the solvent formulation comprises ethylene glycol in an amount of 1 to 20 vol. %.

8. The solvent formulation of claim 6, wherein the solvent formulations comprises triethylene glycol in an amount of 1 to 35 vol. %.

9. The solvent formulation of claim 1, wherein the solvent formulation further comprises a polyol.

10. The solvent formulation of claim 9, wherein the polyol comprises a polyethylene glycol.

11. The solvent formulation of claim 1 wherein the freezing point is −40° C. or lower.

12. The solvent formulation of claim 1 wherein the amino acid salt is present in the solvent formulation in a concentration of from 1 to 6 M.

13. The solvent formulation of claim 12 wherein the amino acid salt is present in the solvent formulation in a concentration of from 2 to 4 M.

14. The solvent formulation of claim 13 wherein the amino acid salt is present in the solvent formulation in a concentration of about 3 M.

15. A direct air capture (DAC) system for the direct air capture of carbon dioxide, the DAC system comprising:
a desorption column;
a gas-liquid separator; and
an air contactor;
wherein the desorption column, gas-liquid separator, and air contactor are in fluid communication; and
wherein the air contactor comprises a solvent formulation comprising:
an amino acid salt;
a polar solvent; and
an antifreeze agent.

16. The DAC system of claim 15, wherein the amino acid salt comprises potassium sarcosinate.

17. The DAC system of claim 15, wherein the polar solvent comprises water.

18. The DAC system of claim 15, wherein the antifreeze agent comprises a glycol.

19. The DAC system of claim 18, wherein the glycol comprises ethylene glycol.

20. The DAC system of claim 18, wherein the glycol comprises triethylene glycol.
